(19) United States
(12) Patent Application Publication
(10) Pub. No.: US 2015/0278863 A1
(43) Pub. Date: Oct. 1, 2015

(54) INFORMATION PROCESSING METHOD, AUDIO SIGNAL-BASED TRANSACTION METHOD, AND SERVER SYSTEM

(71) Applicant: Softfoundry International Pte Ltd., Singapore (SG)

(72) Inventor: Kuan-Lan WANG, Taipei City (TW)

(21) Appl. No.: 14/531,550

(22) Filed: Nov. 3, 2014

(30) Foreign Application Priority Data
Mar. 31, 2014 (TW) 103111983

(51) Int. Cl. G06Q 30/02; G10L 21/0208; G06Q 20/08

(52) U.S. Cl. CPC G06Q 30/0257; G06Q 20/08; G10L 21/0208

(57) ABSTRACT

In an information processing method, an audio conversion process is performed upon an audio fragment of a source audio signal so as to obtain initial audio data. The initial audio data is subsequently processed so as to obtain reference track data that retain primary track features of the audio fragment of the source audio signal and that have background noise removed therefrom. The reference track data is associated to corresponding information content. When the reference track data is determined to be similar to inputted track data, information content corresponding to the reference track data is outputted.

### CROSS-REFERENCE TO RELATED APPLICATION

This application claims priority of Taiwanese Application No. 103111983, filed on Mar. 31, 2014.

### FIELD OF THE INVENTION

The invention relates to an information processing method, an audio signal-based transaction method, and a S system that executes the audio signal-based transaction method.

### BACKGROUND OF THE INVENTION

It is known that an audio signal (e.g., voice of a user) can be processed into a computer-readable signal for a number of purposes. For example, a sentence spoken by the user may be received by a computer interface for extracting the words contained in the sentence, allowing the user to speak out a command to the computer. In another example, a distinct voice of a user can be used as a means of identification.

A commercial advertisement is for promoting a commodity. Audio-based commercial advertisement is very common nowadays, and can be heard broadcasting from a wide variety of media such as a radio, a telephone, a television, a website, etc.

However, even though the offer for the commodity may be attractive to a listener, the commercial advertisement lacks a means to further interact with the listener (e.g., providing the listener with more details about the commodity and/or a way to directly purchase the commodity).

Therefore, it may be beneficial to provide a means for enabling a consumer to interact with the commercial advertisement.

### SUMMARY OF THE INVENTION

One object of the present invention is to provide an information processing method. The information processing method comprises the following steps of:

(a) performing, using a processor, an audio conversion process upon an audio fragment of a source audio signal so as to obtain initial audio data;

(b) processing, using a processor, the initial audio data so as to obtain reference track data that retain primary track features of the audio fragment of the source audio signal and that have background noise removed therefrom;

(c) associating, using a processor, the reference track data to corresponding information content; and

(d) using a processor, determining whether the reference track data is similar to inputted track data, and output ting the information content corresponding to the reference track data when the reference track data is determined to be similar to the inputted track data.

Another object of the present invention is to provide an audio-based transaction method. The transaction method is to be implemented using a transaction system that receives an audio fragment of an inputted audio signal from a client device. The transaction method comprises the following steps of:

(a) performing, using a processor, an audio conversion process upon the audio fragment of the inputted audio signal so as to obtain initial audio data;

(b) processing, using a processor, the initial audio data so as to obtain inputted track data that retain primary track features of the audio fragment of the inputted audio signal and that have background noise removed therefrom;

(c) using a processor, determining whether the inputted track data is similar to reference track data stored in the transaction system, and outputting, to the client device, information content pre-established in the transaction system and corresponding to the reference track data when the inputted track data is determined to be similar to the reference track data; and

(d) in response to receipt of a transaction request issued by the client device and related to the information content outputted in step (c), performing a transaction process corresponding to the transaction request using a processor.

Still another object of the present invention is to provide a transaction system and a server system that are configured to execute the above-mentioned methods.

According to one aspect, a transaction system comprises an audio conversion module, an audio processing module, a data storage module, a determination module, an output module, and a transaction module.

The audio conversion module is configured to perform an audio conversion process upon an audio fragment of an inputted audio signal so as to obtain initial audio data.

The audio processing module is configured to process the initial audio data so as to obtain inputted track data that retain primary track features of the audio fragment of the inputted audio signal and that have background noise removed therefrom.

The data storage module is configured to store reference track data and information content corresponding to the reference track data.

The determination module is configured to determine whether the inputted track data is similar to the reference track data.

The output module is configured to output the information content corresponding to the reference track data when the inputted track data is determined to be similar to the reference track data.

The transaction module, in response to receipt of a transaction request related to the information content outputted by the output module, is configured to perform a transaction process corresponding to the transaction request.

According to another aspect, a server system comprises an account server and an audio management server.

The account server stores account information corresponding to an advertising client device, and is configured to receive a source audio signal from the advertising client device and information content corresponding to the source audio signal.

The audio management server is configured to perform an audio conversion process upon audio fragments of the source audio signal so as to obtain initial audio data, to process the initial audio data so as to obtain reference track data that retain primary track features of the audio fragments of the source audio signal and that have background noise removed therefrom, and to associate the reference track data to the corresponding information content.

Still another object of the present invention is to provide a method for audio signal processing. The method is to be implemented using a processor and comprises:

(a) forming a to-be-processed signal from an audio fragment of a source audio signal by dividing the audio fragment into smaller fragments and arranging the smaller fragments so that temporally adjacent ones of the smaller fragments partially overlap;

(b) subjecting the to-be-processed signal to Fourier transformation processing, followed by wavelet transformation processing, to obtain sets of peak frequency values for different time points within a time duration of the audio fragment;

(c) obtaining a time versus frequency relationship based on the sets of peak frequency values obtained in step (b); and

(d) converting the time versus frequency relationship obtained in step (c) into a binary sparse matrix.

### BRIEF DESCRIPTION OF THE DRAWINGS

Other features and advantages of the present invention will become apparent in the following detailed description of the embodiments with reference to the accompanying drawings, of which:

FIG. 1 is a schematic diagram of a server system according to an embodiment of the present invention;

FIG. 2 is a flow chart of a method for audio signal processing, according to an embodiment of the present invention;

FIG. 3 is a schematic diagram showing an audio fragment being divided into a plurality of smaller fragments;

FIG. 4 is a schematic view of diagram showing sets of peak frequency values for different time points within a time duration, obtained from the audio fragment;

FIG. 5a illustrates a binary sparse matrix and FIG. 5b illustrates the binary sparse matrix with noise removed;

FIGS. 6a and 6b illustrate first and second lower resolution binary sparse matrices, respectively;

FIG. 7 illustrates how reference track data is stored in an integer matrix;

FIG. 8 illustrates how inputted track data is stored in an integer array;

FIGS. 9a and 9b illustrate inputted track data and the reference track data that is to be compared, and FIG. 9c illustrates a result of the comparison; and

FIG. 10 is a flow chart of an audio signal-based transaction method according to an embodiment of the present invention.

### DETAILED DESCRIPTION OF THE EMBODIMENTS

Before the present invention is described in greater detail with reference to the accompanying embodiments, it should be noted herein that like elements are denoted by the same reference numerals throughout the disclosure.

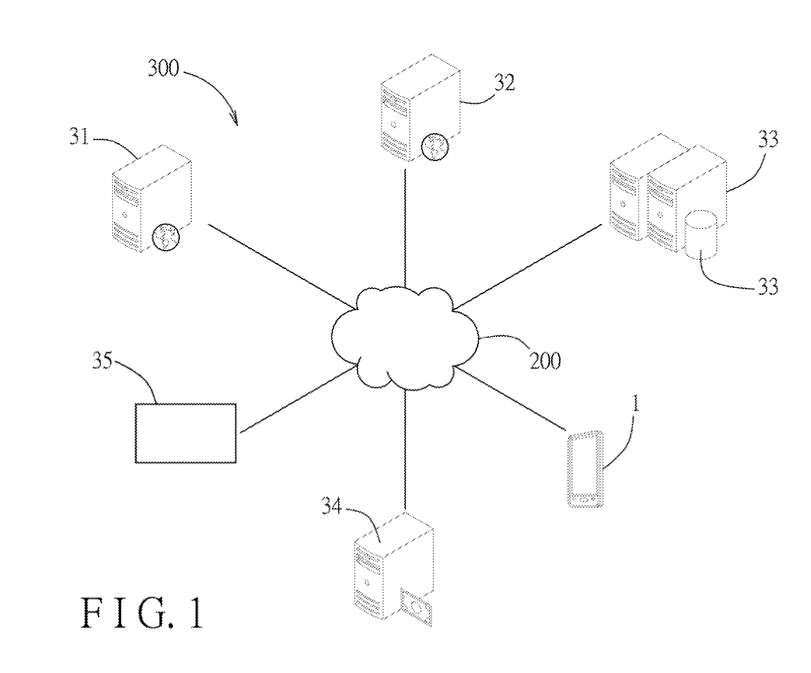

Referring to FIG. 1, a server system 300 according to an embodiment of the present invention comprises a storage medium 30, an interface server 31, an account server 32, and an audio management server 33.

The server system 300 in this embodiment is implemented using Computer Unified Device Architecture (CUDA), and components of the server system 300 are configured to communicate with one another over a network 200. The server system 300 is further configured to communicate with a payment gateway 34 and at least one advertising client device 35 over the network 200.

The interface server 31 is configured to receive a source audio signal from the advertising client device 35 over the network 200. In this embodiment, the advertising client device 35 is a commercial merchant, and the source audio signal contains audio content from a commercial advertisement related to a commodity. The source audio-signal is processed by the audio management server 33 so as to obtain reference track data. The audio management server 33 then stores the reference track data therein. In this embodiment, a plurality of source audio signals, which correspond respectively to a plurality of commercial advertisements, are received from a plurality of advertising client devices 35. The source audio signals are processed, and the corresponding reference track data are stored.

Furthermore, the interface server 31 receives account information corresponding to the advertising client devices 35, and information content corresponding to the source audio signals that are received from the advertising client devices 35. In this embodiment, the information content includes a link to a commodity webpage that contains information of the commodity, and that allows a user to purchase the commodity online. The account information and the information content are then transmitted to the account server 32, which creates an account associated with each of the advertising client device 35 and stores the account information and the information content therein. When the reference track data corresponding to each of the commercial advertisements is generated, the audio management server 33 further associates the reference track data to the corresponding information content.

The commercial advertisements that are transmitted to the interface server 31 may be ones that are publicly broadcasted for common audiences, through a stereo, a telephone, a television, a radio, a website, or a combination thereof. When a customer is interested in the commodity that is being promoted by the commercial advertisement, he or she may operate a customer client device 1 (which may be embodied using, for example, a mobile phone with a sound recording function) to record a fragment of audio content from the commercial advertisement. Preferably, the fragment of audio content from the commercial advertisement has a length of at least five seconds.

In some embodiments, the customer may operate the customer client device 1 to first communicate with the server system 300, and upload the recorded fragment of audio content to the interface server 31 to serve as an inputted audio signal. The inputted audio signal is similarly processed by the server system 300 so as to obtain inputted track data.

The audio management server 33 then attempts to identify one of the commercial advertisements from which the inputted audio signal originates by comparing the inputted track data and the reference track data. When it is determined by the audio management server 33 that the inputted track data corresponds to one of the commercial advertisements, the audio management server 33 outputs the information content corresponding to the reference track data to the account server 32, which in turn transmits the information content to the customer client device 1 for the customer's consideration.

Afterward, when the customer clicks the link included in the information content using the customer client device 1, the customer client device 1 is configured to communicate with the payment gateway 34 for transmitting a transaction request for purchase of the commodity. In response, the payment gateway 34 performs a transaction process corresponding to the transaction request.

Since processing of the transaction request by the payment gateway 34 may be readily appreciated by those skilled in the art (i.e., in the field of e-commerce), details thereof are omitted herein for the sake of brevity.

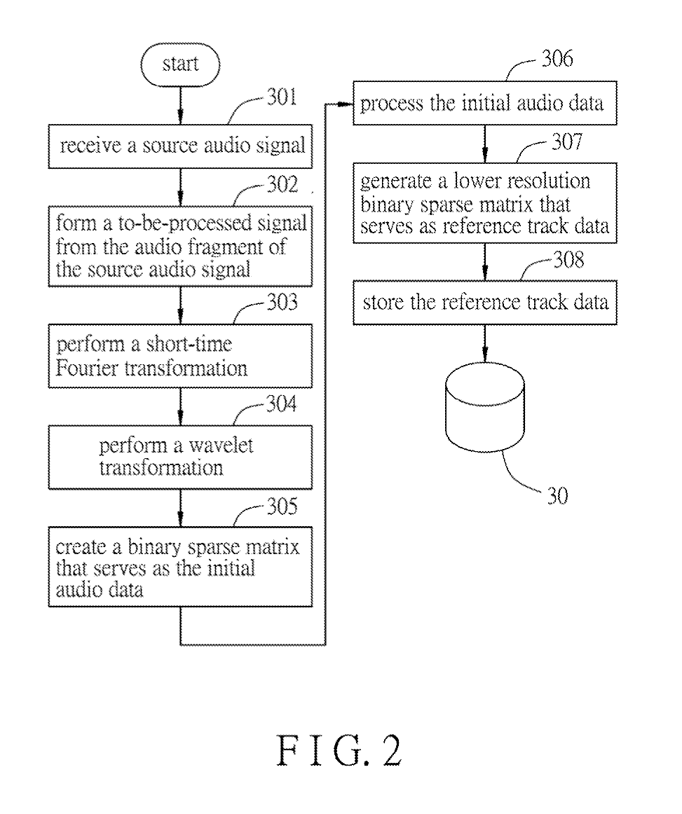

FIG. 2 illustrates steps of a method for audio signal processing, according to an embodiment of the present invention. The method is implemented using the audio management server 33, and is to be applied to the source audio signals and the inputted audio signal received from the advertising client devices 35 and the customer client device 1, respectively, in order to obtain the reference track data and the inputted track data.

In this example, the audio management server 33 first receives a source audio signal from one of the advertising client devices 35 (via the account server 32) in step 301. Afterward, the audio management server 33 performs an audio conversion process upon an audio fragment of the source audio signal, so as to obtain initial audio data.

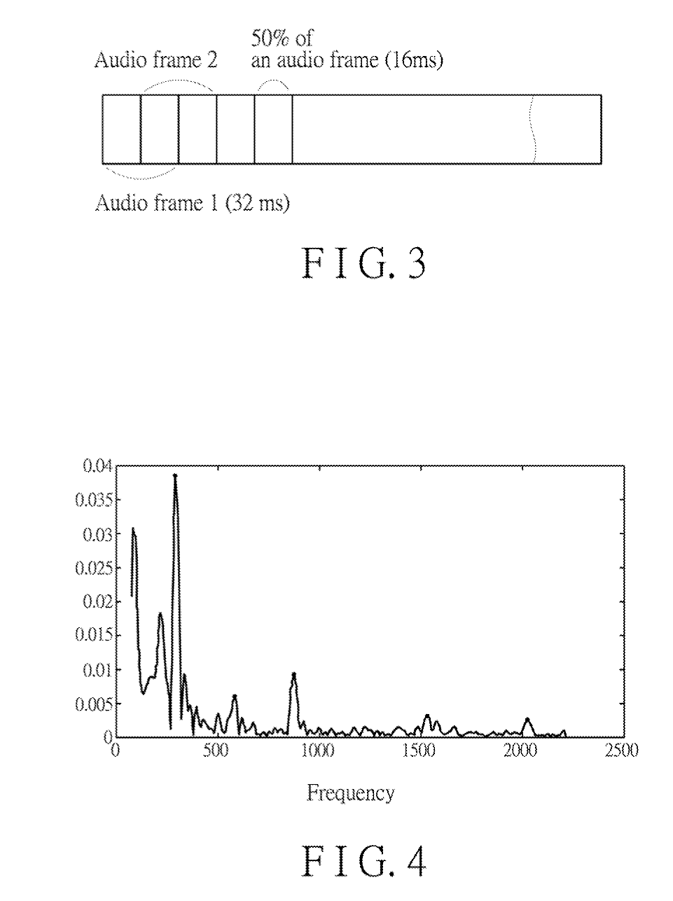

Specifically, in step 302, the audio management server 33 forms a to-be-processed signal from the audio fragment of the source audio signal by dividing the audio fragment into smaller fragments and arranging the smaller fragments so that temporally adjacent ones of the smaller fragments partially overlap. Referring to FIG. 3, in this example, each of the smaller fragments (an audio frame) has a length of 32 milliseconds, and temporally adjacent ones of the smaller fragments are arranged to overlap with each other by 50% (i.e., 16 milliseconds). Then, the to-be-processed signal is subjected to a short-time Fourier transformation (SIFT) processing in step 303, and a wavelet transformation processing in step 304.

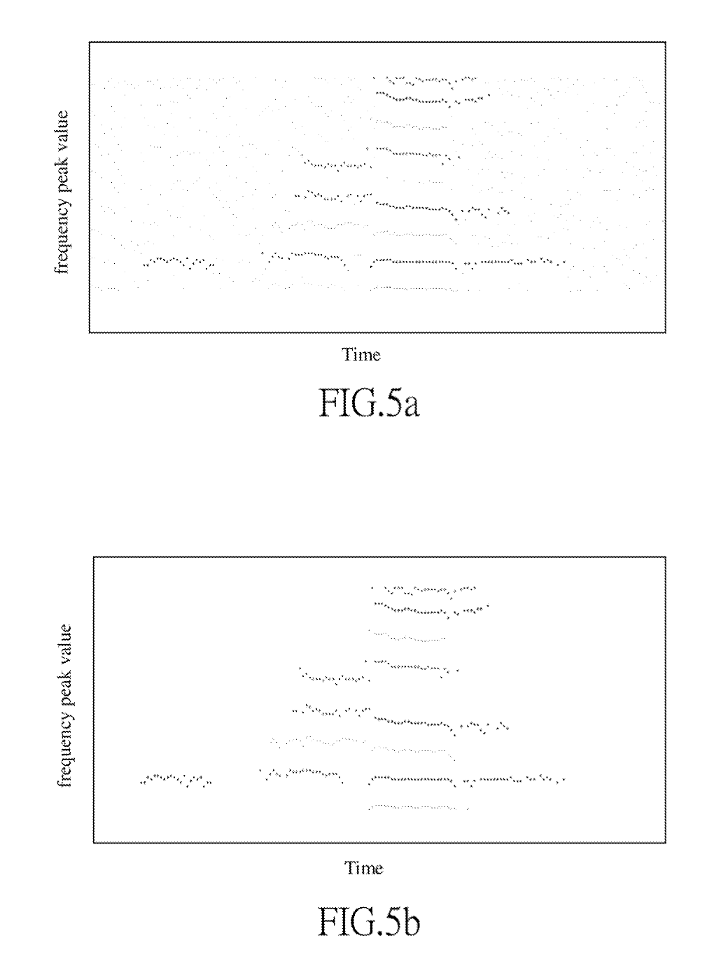

The results obtained from the STFT processing and the wavelet transformation processing on the to-be-processed signal are sets of peak frequency values for different time points within a time duration of the audio fragment (see FIG. 4).

Then, the audio management server 33 obtains a time versus frequency relationship based on the sets of peak frequency values obtained in step 303.

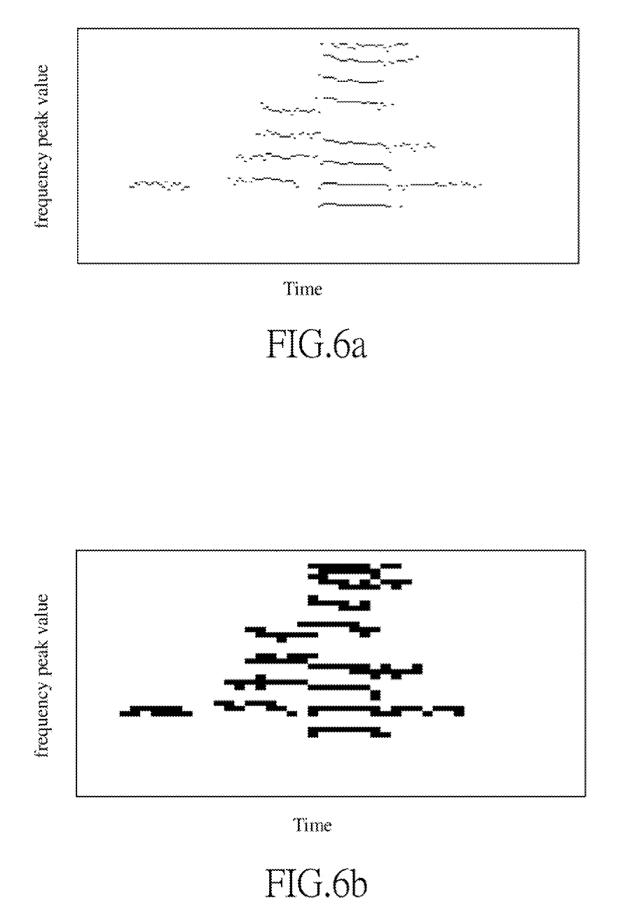

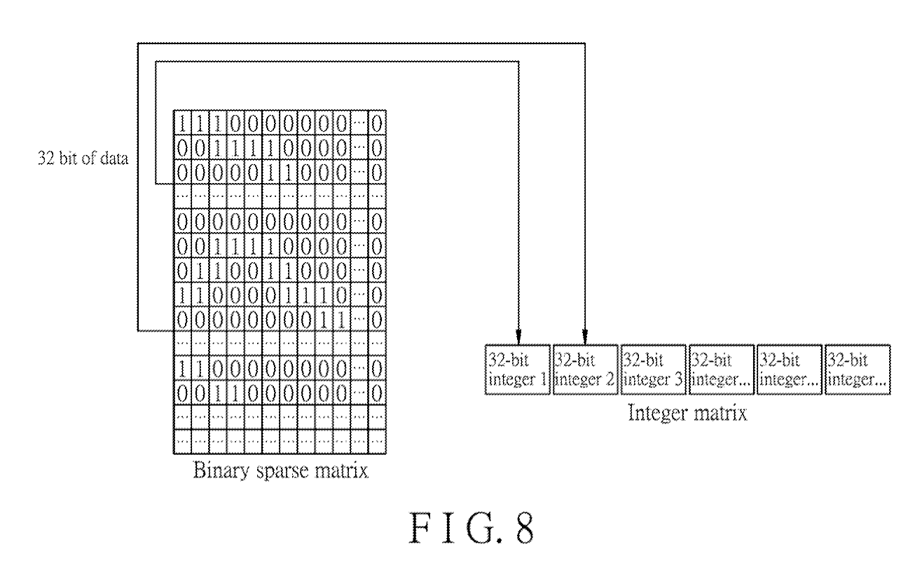

In step 305, the audio management server 33 converts the time versus frequency relationship into a two-dimensional binary sparse matrix (M) that serves as the initial audio data (see FIG. 5a). Further referring to FIG. 7, the binary sparse matrix (M) may be presented in a digital form, with a dot in FIG. 5a corresponding to a digit ‘1’.

In step 306, the audio management server 33 processes the initial audio data so as to obtain reference track data that retain primary track features of the audio fragment of the source audio signal and that have background noise removed therefrom. This may be done by computing the binary sparse matrix according to a density-based clustering algorithm tor removing the background noise. In this example, a density-based spatial clustering of applications with noise (DBSCAN) is utilized. The result is illustrated in FIG. 5b.

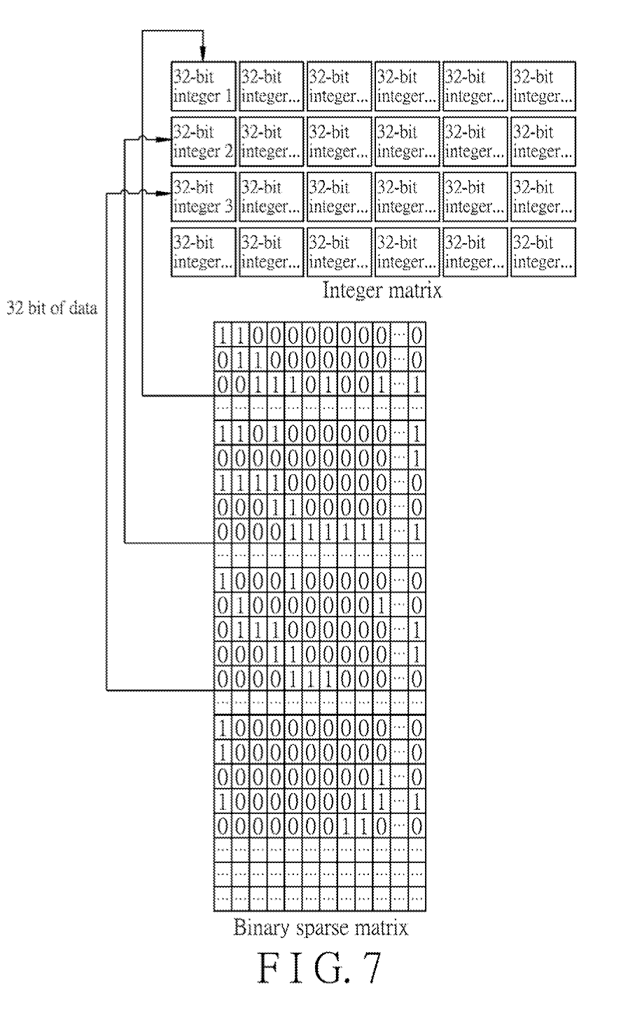

Then, in step 307, the audio management server 33 further generates one or more lower resolution binary sparse matrices based on a computed result of step 306, so as to serve as the reference track data with the binary sparse matrix (M). In this example, two lower resolution binary sparse matrices (namely, a first lower resolution binary sparse matrix (M₁) and a second lower resolution binary sparse matrix (M₂) ) are generated, as shown in FIGS. 6a and 6b, respectively.

In step 308, the reference track data (i.e., the binary sparse matrix (M) and the first and second lower resolution binary sparse matrices (M₁, M₂) ) is outputted and stored in the storage medium 30 as an integer matrix (see FIG. 7). In this example, every 32 bits of data is stored into one 32-bit integer.

It is apparent that, since signals from a large number of commercial advertisements will be received and processed, an advantage of employment of the first and second lower resolution binary sparse matrices (M₁, M₂) is that it requires a smaller amount of memory space to store the first and second lower resolution binary sparse matrices (M₁, M₂) than the binary sparse matrix (M).

Specifically, in this example, the binary sparse matrix (M) obtained from a 30-second audio fragment has 256 rows and 1872 columns. In turn, with every 32 bits stored using one 32-bit integer, the binary sparse matrix (M) can be stored using 8*1872 integers. Accordingly, the first lower resolution binary sparse matrices (M₁) may have a size of 128 rows and 936 columns, and can be stored using 4*936 integers. The second lower resolution binary sparse matrices (M₂) may have a size of 64 rows and 468 columns, and can be stored using 2*468 integers.

The memory space needed to store the binary sparse matrix (M) is roughly 60 kilobytes (KB). On the other hand, the first and second lower resolution binary sparse matrices (M₁, M₂) only require roughly 15 KB and 3.7 KB of memory space to store, respectively. When it is decided to store the first and second lower resolution binary sparse matrices (M₁, M₂) instead of the binary sparse matrix (M), only 18.7 KB of memory space is required.

In this example, the storage medium 30 includes four memory cards dedicated to storing the reference track data. The memory cards are compatible with CUDA, and have a combined memory space of 24 gigabytes (GB). Using such a configuration, the four memory cards are able to store reference track data obtained from roughly 1.2 million source audio signals.

Similarly, when an inputted audio signal is recorded by the customer client device 1, an audio conversion process is performed upon an audio fragment of the inputted audio signal so as to obtain initial inputted audio data. The initial inputted audio data is then processed to obtain inputted track data (in the form of the binary sparse matrices (M, M₁ and M₂) ).

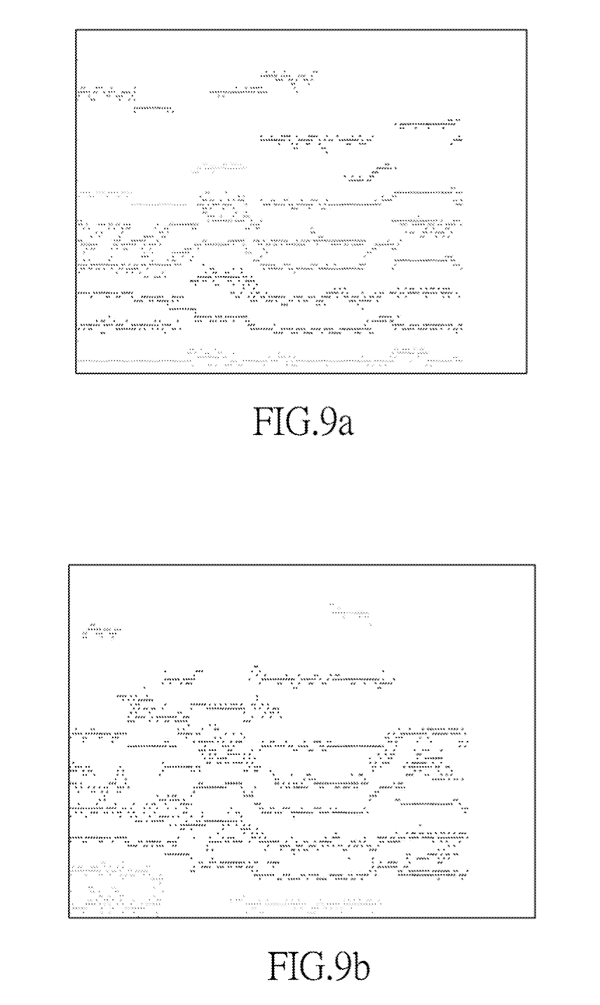

Afterward, the inputted track data is stored as an integer array (see FIG. 8). For a 10-second inputted audio signal, the binary sparse matrix (M) has 256 rows and 624 columns, and can be stored using 8*624 32-bit integers (20 KB of memory space). The first and second lower resolution binary sparse matrices (M₁, M₂) only require 5 KB and 1.28 KB of memory space to store, respectively. When it is decided to store the first and second lower resolution binary sparse matrices (M₁, M₂) instead of the binary sparse matrix (M), only roughly 6.3 KB of memory space is required. That is, in an embodiment where the customer client device 1 is configured to perform audio conversion process upon an inputted audio signal, followed by processing to obtain the inputted track data in the manner described hereinabove for subsequent transmission to the audio-management server 33 for identification, only roughly 6.3 KB of data is transmitted.

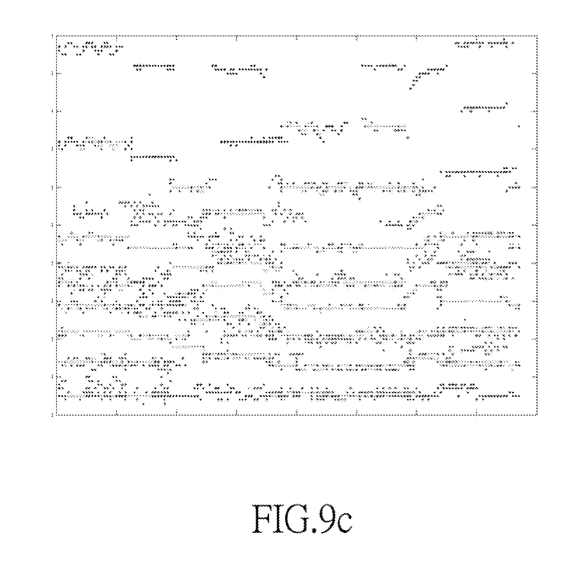

Referring to FIGS. 9a to 9c, the audio management server 33 is now ready to determine a target advertisement (i.e., the commercial advertisement from which the client device 1 recorded the inputted audio signal) from a plurality of candidate advertisements whose audio data have been processed and stored in the storage medium 30 as reference track data. In this embodiment, the audio management server 33 compares the inputted track data (see FIG. 9a) and the reference track data stored in the storage medium 30 (see FIG. 9b for an example).

In operation, the audio management server 33 first compares the second lower resolution binary sparse matrices (M₂) of the inputted track data and the reference track data. A logic AND operation is performed to determine whether one 32-bit integer in the second lower resolution binary sparse matrices of the inputted track data is identical to a corresponding 32-bit integer in the second lower resolution binary sparse matrices (M₂) of the reference track data (that is, whether the 32-bit integers constitute a “match”). FIG. 9c illustrates a result of the comparison, with a black dot representing a “match”.

The above operation using the second lower resolution binary sparse matrices (M₂) is able to eliminate candidate advertisements that are less likely to be the one from which the inputted audio signal was recorded, based on the number of matches. That is, the candidate advertisements with less detected matches detected with the inputted track data are considered unlikely to be the target commercial, and are subsequently discarded from consideration. A second operation using the first lower resolution binary sparse matrices (M₁) of the inputted track data and the first lower resolution binary sparse matrices (M₁) of the remaining candidate advertisements maybe performed to further narrow down the possible candidate advertisements. Afterwards, when the target advertisement is still undecided, a third operation using the binary sparse matrices (M) may be performed.

After the target advertisement is determined, the account server 32 is configured to output, to the client device 1, the information content corresponding to the reference track data of the target advertisement.

The user of the customer client device 1 is then able to view the information content of the commodity promoted by the target advertisement. When the user is interested with the commodity, he/she may click the link to the commodity webpage, and communicate with the payment gateway 34 for sending a transaction request.

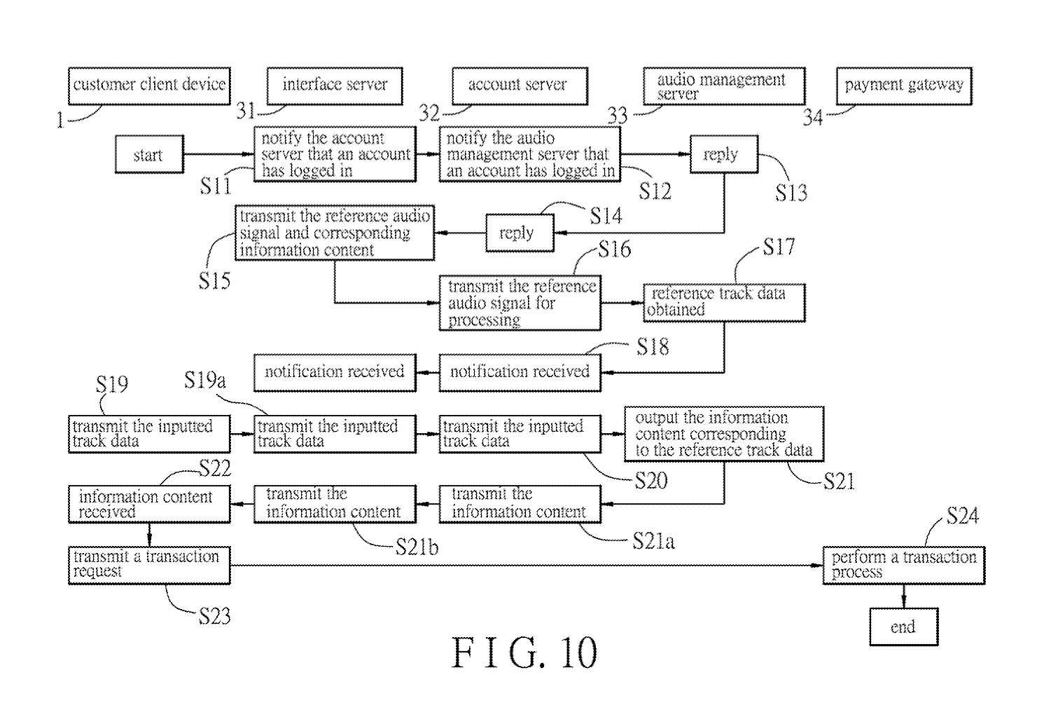

The operation of the server system 300 may be summarised by an audio signal-based transaction method as illustrated in FIG. 10.

In step S11, after the customer client device 1 has established a connection to the interface server 31, the interface server 31 notifies the account server 32 that an account associated with the customer client device 1 has logged in. In turn, in step S12, the account server 32 notifies the audio management server 33 to allocate necessary resource for the incoming inquiry by the client device 1. In response, the audio management server 33 performs the requested operation and notifies the account server 32 in step S13, and the account server 32 replies to the interface server 31 in step S14.

In step S15, the interface server 31 receives the source audio signals representing the candidate commercial advertisements and the corresponding information content from the advertising client device 35, and transmits the same to the account server 32. In step S16, the account server 32 transmits the source audio signal to the audio management server 33 for processing.

The audio management server 33 processes the source audio signal to obtain the reference track data and associates the reference track data to the corresponding information content. Afterward, the audio management server 33 notifies the account server 32 in step S17 that the reference track data has been obtained. The account server 32 then notifies the interface server 31 in step S18.

It is noted that in other embodiments, steps S15 to S18 may be executed before the audio signal-based transaction method. That is, the reference track data may be prepared beforehand.

In step S19, the interface server 31 receives the inputted track data from the client device 1, and transmits the same to the audio management server 33 in step S20.

The audio management server 33 determines the target advertisements having the reference track data that is most similar to the inputted track data, and, in step S21, outputs the information content corresponding to the reference track data to the account server 32. The information content is then provided to the customer client device 1 in step S22.

The information content contains a link to the payment gateway 34 for purchasing the commodity promoted by the target advertisement, and the user is able to transmit a transaction request to the payment gateway 34 in step S23. In response, the payment gateway 34 is configured to perform a transaction process in step S24.

In some embodiments, the audio management server 33 may be farther configured to record a number of times a specific candidate advertisement has been inquired. That is, a number of times each of the candidate advertisements being determined to be the target advertisement. Such a record may be fed back to the commercial advertisement provider for studying customer interest and an effect of each of the broadcasted commercial advertisements.

To sum up, embodiments of the present invention provide a relatively simple way for allowing a user to interact with an ordinary commercial advertisement by recording the commercial advertisement and uploading the inputted audio signal to the server system 300. For a commercial advertisement provider, keeping track of a number of inquiries from the users may be beneficial for studying customer interest and an effect of the broadcasted commercial advertisements.

While the present invention has been described in connection with what are considered the most practical embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An information processing method, comprising the following steps of:
(a) performing, using a processor, an audio conversion process upon an audio fragment of a source audio signal so as to obtain initial audio data;
(b) processing, using a processor, the initial audio data so as to obtain reference track data that retain primary track features of the audio fragment of the source audio signal and that have background noise removed therefrom;
(c) associating, using a processor, the reference track data to corresponding information content; and
(d) using a processor, determining whether the reference track data is similar to inputted track data, and outputting the information content corresponding to the reference track data when the reference track data is determined to be similar to the inputted track data.

2. The method of claim 1, wherein the audio conversion process includes the following sub-steps:
(a1) forming a to-be-processed signal from the audio fragment of the source audio signal by dividing the audio fragment into smaller fragments and arranging the smaller fragments so that temporally adjacent ones of the smaller fragments partially overlap;
(a2) subjecting the to-be-processed signal to Fourier transformation processing, followed by wavelet transformation processing, to obtain sets of peak frequency values for different time points within a time duration of the audio fragment;
(a3) obtaining a time versus frequency relationship based on the sets of peak frequency values obtained in sub-step (a2); and
(a4) converting the time versus frequency relationship obtained in sub-step (a3) into a binary sparse matrix that serves as the initial audio data.

3. The method of claim 2, wherein the processing in step (b) includes:
(b1) computing the binary sparse matrix according to a density-based clustering algorithm for removing the background noise.

4. The method of claim 3, wherein the processing in step (b) further includes:
(b2) generating a lower resolution binary sparse matrix based on a computed result of sub-step (b1) to serve as the reference track data.

5. An audio signal-based transaction method to be implemented using a transaction system that receives an audio fragment of an inputted audio signal from a client device, said transaction method comprising the following steps of:
(a) performing, using a processor, an audio conversion process upon the audio fragment of the inputted audio signal so as to obtain initial audio data;
(b) processing, using a processor, the initial audio data so as to obtain inputted track data that retain primary track features of tire audio fragment of the inputted audio signal and that have background noise removed therefrom;
(c) using a processor, determining whether the inputted track data is similar to reference track data stored, in the transaction system, and outputting, to the client device, information content pre-established in the transaction system and corresponding to the reference track data when the inputted track data is determined to be similar to the reference track data; and
(d) in response to receipt of a transaction request issued by the client device and related to the information content outputted in step (c), performing a transaction process corresponding to the transaction request using a processor.

6. The audio signal-based transaction method of claim 5, wherein the audio conversion process includes the following sub-steps:
(a1) forming a to-be-processed signal from the audio fragment of the inputted audio signal by dividing the audio fragment into smaller fragments and arranging the smaller fragments so that temporally adjacent ones of the smaller fragments partially overlap;
(a2) subjecting the to-be-processed signal to Fourier transformation processing, followed by wavelet transformation processing, to obtain sets of peak frequency values for different time points within a time duration of the audio fragment;
(a3) obtaining a time versus frequency relationship based on the sets of peak frequency values obtained in sub-step (a2); and
(a4) converting the time versus frequency relationship obtained in sub-step (a3) into a binary sparse matrix that serves as the initial audio data.

7. The audio signal-based transaction method of claim 6, wherein the processing in step (b) includes:
(b1) computing the binary sparse matrix according to a density-based clustering algorithm for removing the background noise.

8. The audio signal-based transaction method of claim 7, wherein the processing in step (b) further includes:
(b2) generating a lower resolution binary sparse matrix based on a computed result of sub-step (b1) to serve as the inputted track data.

9. A transaction system comprising;
an audio conversion module configured to perform an audio conversion process upon an audio fragment of an inputted audio signal so as to obtain initial audio data;
an audio processing module configured to process the initial audio data so as to obtain inputted track data that retain primary track features of the audio fragment of the inputted audio signal and that have background noise removed therefrom;
a data storage module configured to store reference track data and information content corresponding to the reference track data;
a determination module configured to determine whether the inputted track data is similar to the reference track data;
an output module configured to output the information content corresponding to the reference track data when the inputted track data is determined to be similar to the reference track data; and
a transaction module that is, in response to receipt of a transaction request related to the information content outputted by said output module, configured to perform a transaction process corresponding to the transaction request.

10. The transaction system of claim 9, wherein said audio conversion module is configured to:
form a to-be-processed signal from the audio fragment of the inputted audio signal by dividing the audio fragment into smaller fragments and arranging the smaller fragments so that temporally adjacent ones of the smaller fragments partially overlap;
subject the to-be-processed signal to Fourier transformation processing, followed by wavelet transformation processing, to obtain sets of peak frequency values for different time points within a time duration of the audio fragment;
obtain a time versus frequency relationship based on the sets of peak frequency values thus obtained; and
convert the time versus frequency relationship thus obtained into a binary sparse matrix that serves as the initial audio data.

11. The transaction system of claim 10, wherein said audio processing module is configured to compute the binary sparse matrix according to a density-based clustering algorithm for removing the background noise.

12. The transaction system of claim 11, wherein said audio processing module is further configured to generate a lower resolution binary sparse matrix based on a computed result of the density-based clustering algorithm to serve as the inputted track data.

13. A server system comprising:
an account server that stores account information corresponding to an advertising client device, and that is configured to receive a source audio signal from the advertising client device and information content corresponding to the source audio signal; and
an audio management server that is configured to perform an audio conversion process upon audio fragments of the source audio signal so as to obtain initial audio data, to process the initial audio data so as to obtain reference track data that retain primary track features of the audio fragments of the source audio signal and that have background noise removed therefrom, and to associate the reference track data to the corresponding information content.

14. The server system of claim 13, wherein the source audio signal is from a commercial advertisement related to a commodity, and the corresponding information content includes a link to a commodity webpage containing information of the commodity.

15. The server system of claim 13, wherein said account server further stores account information of a customer client device, and is farther configured to receive an inputted audio signal from the customer client device,
wherein said audio management server is further configured to perform the audio conversion process upon the inputted audio signal so as to obtain initial inputted audio data, to process the initial inputted audio data so as to obtain inputted track data that retain primary track features of the inputted audio signal and that have background noise removed therefrom, determine whether the reference track data is similar to the inputted track data, and output the information content corresponding to the reference track data to said account server when the reference track data is determined to be similar to the inputted track data, and
wherein said account server is configured to provide the information content received from said audio management server to the customer client device.

16. A method for audio signal processing to be implemented using a processor, comprising:
(a) forming a to-be-processed signal from an audio fragment of a source audio signal by dividing the audio fragment into smaller fragments and arranging the smaller fragments so that temporally adjacent ones of the smaller fragments partially overlap;
(b) subjecting the to-be-processed signal to Fourier transformation processing, followed by wavelet transformation processing, to obtain sets of peak frequency values for different time points within a time duration of the audio fragment;
(c) obtaining a time versus frequency relationship based on the sets of peak frequency values obtained in step (b); and
(d) converting the time versus frequency relationship obtained in step (c) into a binary sparse matrix.

17. The method of claim 16, further comprising:
(e) computing the binary sparse matrix according to a density-based clustering algorithm for removing background noise.

18. The method of claim 17, further comprising:
generating a lower resolution binary sparse matrix based on a computed result of step (e).
